(19) United States
(12) Patent Application Publication
(10) Pub. No.: US 2022/0391787 A1
(43) Pub. Date: Dec. 8, 2022

(54) Playrlist

(71) Applicant: Shaddaii Harris, Arlington, TX (US)

(72) Inventor: Shaddaii Harris, Arlington, TX (US)

(21) Appl. No.: 17/339,942

(22) Filed: Jun. 5, 2021

(51) Int. Cl. G06Q 10/06; G06F 21/31

(52) U.S. Cl. CPC G06Q 10/063; G06F 21/31

(57) ABSTRACT

A software/app for housing companies' contact information directly, which is sent to athletes based on his/her needs.

### BRIEF SUMMARY

Pro athletes will now have access to this software to search for and obtain services from the companies housed within the software/application. Companies/brands will now have access to inquiries players submit.

### DRAWINGS EXPLAINED

FIG. 1— Application on cellular device

FIG. 2— Application/software on desktop/laptop

FIG. 3— Accessing Application/software

FIG. 4.— User Login

FIG. 5.— Customized Profile (athletes)

FIG. 6.—Finding a match

FIG. 7.— Customized Companies (notified)

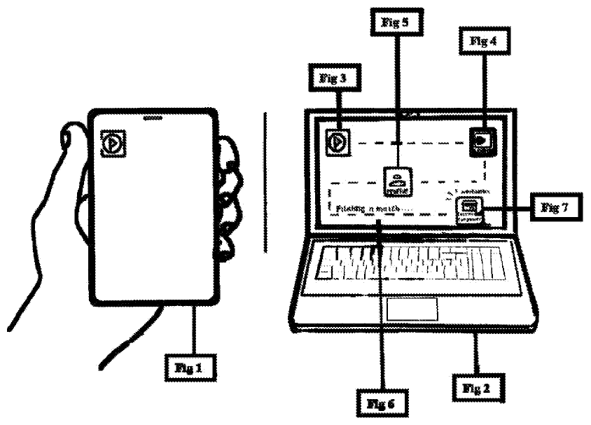

1. A method compromising—
Step 1— Athletes or Companies access the software/app via phone or computer/laptop.
Step 2— Athletes or Companies use confidential login information to access his/her user profile. STEP 3— Athletes access the software and select the needs/services.
Step 4— The software matches the athletes with companies (demographics, needs, and schedule).
Step 5— After finding the match, the software sends the selected companies' website/contact information, and a company bio to the athlete's playlist (directory).
Step 6— Companies are notified when their company is selected.
